(19) United States
(12) Patent Application Publication
(10) Pub. No.: US 2009/0030990 A1
(43) Pub. Date: Jan. 29, 2009

(54) Tunneling Artifacts Through Instant Messengers

(76) Inventor: Naveenkumar V. Muguda, Cary, NC (US)

Correspondence Address: DILLON & YUDELL LLP, 8911 N. CAPITAL OF TEXAS HWY., SUITE 2110, AUSTIN, TX, 78759, US

(21) Appl. No.: 11/828,043

(22) Filed: Jul. 25, 2007

(51) Int. Cl. G06F 15/16

(52) U.S. Cl. 709/206

(57) ABSTRACT

An interactive teleconference includes a text messaging session between a first user and second user. A collaborative pipe is attendant to, but invisible to, the text messaging session. The collaborative pipe allows artifacts, from a first application used by the first user, to be transmitted to a second application used by the second user without underlying logic in the text messaging session being aware of the artifact transmission.

### BACKGROUND OF THE INVENTION

The present disclosure relates to the field of computers, and specifically to software. Still more specifically, the present disclosure relates to interactive instant messaging sessions.

Instant messaging technology is used to communicate either to an individual via peer to peer chats, or to a group of individuals through establishing a group chat discussion where 1 to n (where “n” is an integer) individuals can join. Such instant messaging has become an integral part of both personal and professional lives, and is often replacing and supplementing well known means of communication such as email, phone and face-to-face conversations.

### BRIEF SUMMARY OF THE INVENTION

A text messaging session involves two users, a first user and second user. A collaborative pipe is attendant to, but invisible to, the text messaging session. The collaborative pipe allows artifacts, from a first application used by the first user, to be transmitted to a second application used by the second user without underlying logic in the text messaging session being aware of the artifact.

The above as well as additional objectives, features, and advantages of the present invention will become apparent in the following detailed written description.

### BRIEF DESCRIPTION OF THE SEVERAL VIEWS OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 depicts an exemplary computer in which the present invention may be implemented;

FIG. 2 illustrates a relationship between a first user and a second user in an Instant Messaging (IM) session;

FIG. 3 depicts additional detail of a collaborative pipe between the first and second users shown in FIG. 2;

FIG. 4 illustrates an alternate embodiment of the collaborative pipe shown in FIG. 3;

FIG. 5 depicts an exemplary Graphical User Interface (GUI) that allows a user to utilize an artifact that has been sent through the collaborative pipes shown in FIGS. 3-4; and

FIG. 6 is a flow-chart of exemplary steps taken to utilize a collaborative pipe to transmit artifacts.

### DETAILED DESCRIPTION OF THE INVENTION

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatuses (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

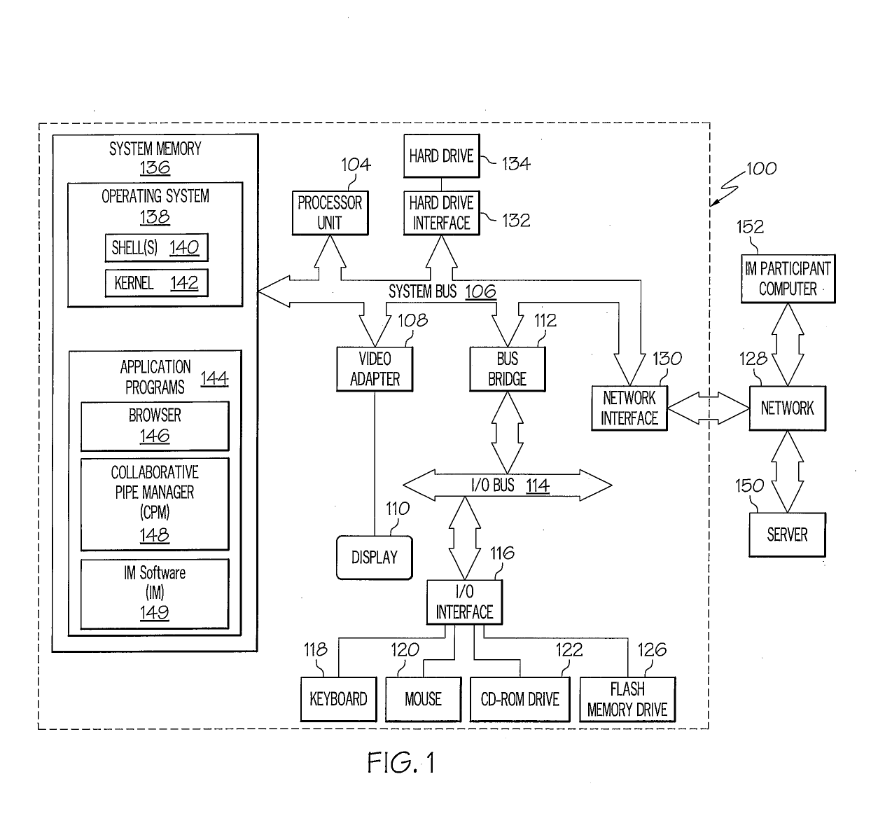

With reference now to FIG. 1, there is depicted a block diagram of an exemplary computer 100, with which the present invention may be utilized. Computer 100 includes a processor unit 104 that is coupled to a system bus 106. A video adapter 108, which drives/supports a display 110, is also coupled to system bus 106. System bus 106 is coupled via a bus bridge 112 to an Input/Output (I/O) bus 114. An I/O interface 116 is coupled to I/O bus 114. I/O interface 116 affords communication with various I/O devices, including a keyboard 118, a mouse 120, a Compact Disk-Read Only Memory (CD-ROM) drive 122, and a flash memory drive 126. The format of the ports connected to I/O interface 116 may be any known to those skilled in the art of computer architecture, including but not limited to Universal Serial Bus (USB) ports.

Computer 100 is able to communicate with a server 150 and an IM Participant Computer 152 via a network 128 using a network interface 130, which is coupled to system bus 106. Network 128 may be an external network such as the Internet, or an internal network such as an Ethernet or a Virtual Private Network (VPN). Server 150 and IM Participant Computer 152 may be architecturally configured in the manner that is substantially similar to that depicted for computer 100. In a preferred embodiment, computer 100 is utilized by a first participant in an IM or similar interactive teleconference session, and IM participant computer 152 is used by a second participant in the interactive teleconference session.

A hard drive interface 132 is also coupled to system bus 106. Hard drive interface 132 interfaces with a hard drive 134. In one embodiment, hard drive 134 populates a system memory 136, which is also coupled to system bus 106. System memory 136 is defined as a lowest level of volatile memory in computer 100. This volatile memory may include additional higher levels of volatile memory (not shown), including, but not limited to, cache memory, registers, and buffers. Code that populates system memory 136 includes an operating system (OS) 138 and application programs 144.

OS 138 includes a shell 140, for providing transparent user access to resources such as application programs 144. Generally, shell 140 (as it is called in UNIX®) is a program that provides an interpreter and an interface between the user and the operating system. Shell 140 provides a system prompt, interprets commands entered by keyboard 118, mouse 120, or other user input media, and sends the interpreted command(s) to the appropriate lower levels of the operating system (e.g., kernel 142) for processing. As depicted, OS 138 also includes kernel 142, which includes lower levels of functionality for OS 138. Kernel 142 provides essential services required by other parts of OS 138 and application programs 144. The services provided by kernel 142 include memory management, process and task management, disk management, and I/O device management.

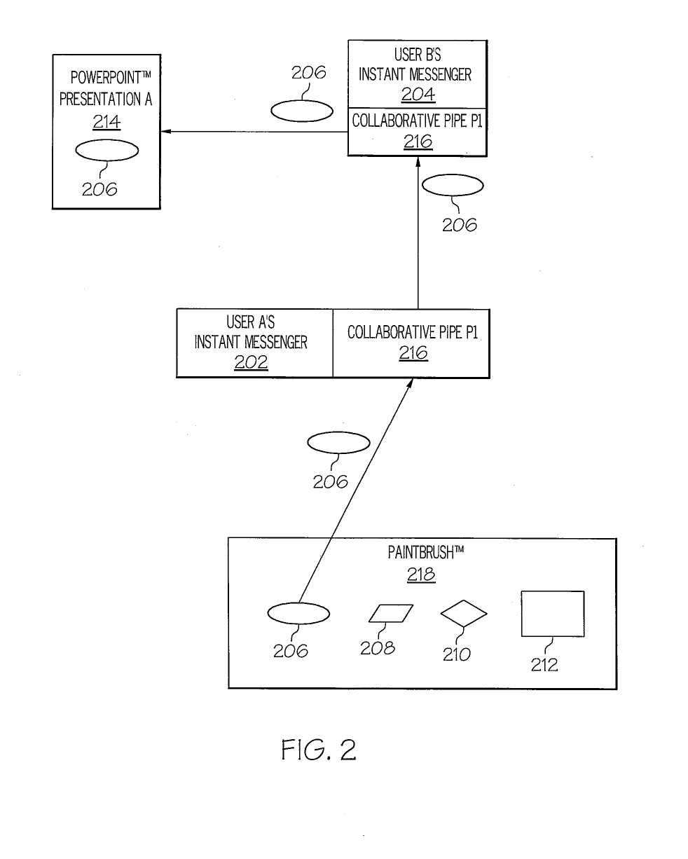

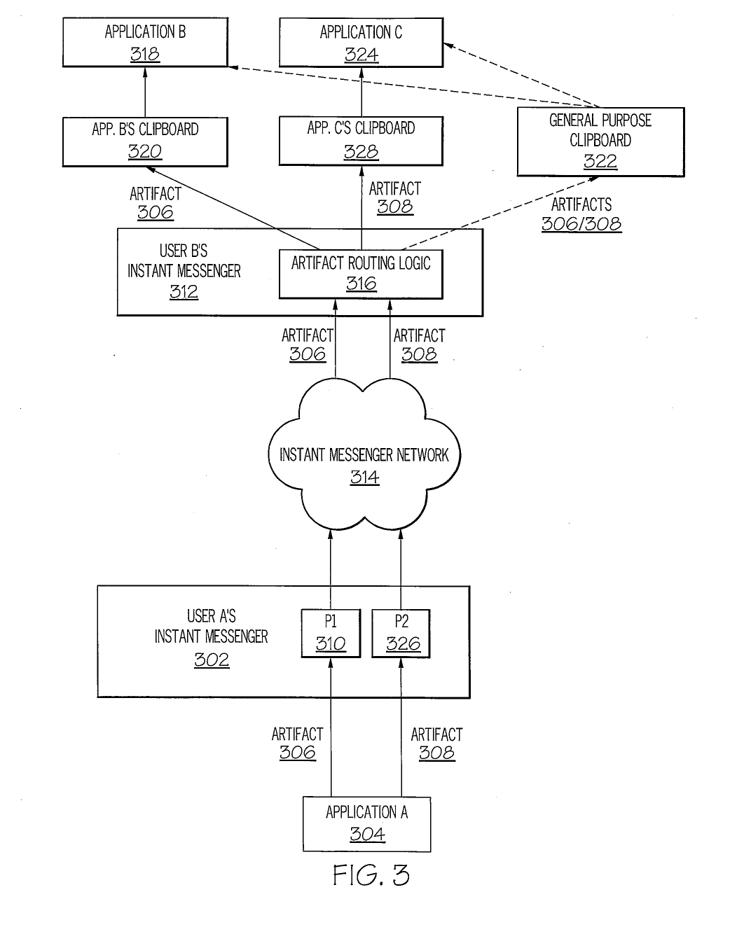

Application programs 144 include a browser 146. Browser 146 includes program modules and instructions enabling a World Wide Web (WWW) client (i.e., computer 100) to send and receive network messages to the Internet. Computer 100 may utilize HyperText Transfer Protocol (HTTP) messaging to enable communication with server 150. Application programs 144 in system memory 136 also include a Collaborative Pipe Manager (CPM) 148 and an IM software (IM) 149. CPM 148 and IM 149 perform the functions illustrated below in FIGS. 2-6, and may include the artifact routing logic 316 and general purpose clipboard 322 shown in FIG. 3. In one embodiment, computer 100 is able to download CPM 148 and/or IM 149 from a service provider that is utilizing server 150, preferably in an “on demand” basis. Note further that, in a preferred embodiment of the present invention, server 150 performs all of the functions associated with the present invention (including the execution of CPM 148 and/or IM 149), thus freeing computer 100 from having to use its own computing resources. Application programs 144 also include other applications such as those shown in FIGS. 2-3, including but not limited to Paintbrush™ 218 shown in FIG. 2 and Application A (304), Application B 318, and Application C 324 shown in FIG. 3.

The hardware elements depicted in computer 100 are not intended to be exhaustive, but rather represent and/or highlight certain components that may be utilized to practice the present invention. For instance, computer 100 may include alternate memory storage devices such as magnetic cassettes, Digital Versatile Disks (DVDs), Bernoulli cartridges, and the like. These and other variations are intended to be within the spirit and scope of the present invention.

The present invention may be utilized in any interactive teleconference environment. An interactive teleconference is understood to include any form of electronic communication between at least two parties and/or devices. Examples of such interactive teleconferences include, but are not limited to, Instant Messaging (IM) sessions, web conferences, video conferences, telephone calls, text message sessions, etc. While it is to be understood that the novelties disclosed herein are applicable to any such interactive teleconference environments, for the sake of brevity and clarity, the invention is primarily described herein in the environment of a text-based IM session.

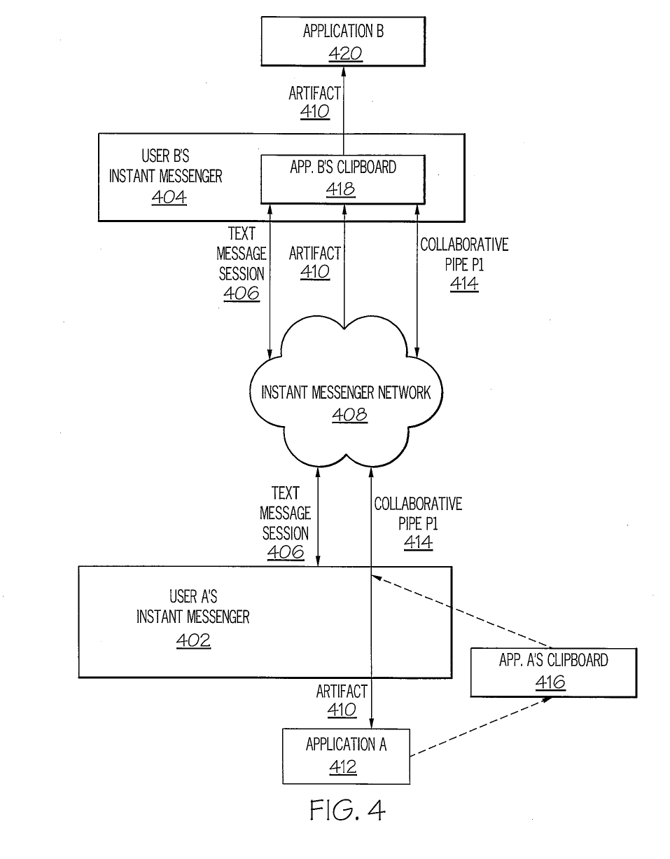

With reference then to FIG. 2, an exemplary environment for an IM session in accordance with the present invention is presented. A first user's IM 202 (User A) is coupled to a second user's IM 204 (User B). Note that the term “IM” is intended to describe a hardware and software combination that facilitates an IM session. Thus, first user's IM 202 may utilize computer 100 while second user's IM 204 may utilize IM participant computer 152 shown in FIG. 1. For exemplary purposes, assume that User A has created four figures using a graphics program such as Microsoft's™ Paintbrush™ 218. These four figures include an ellipse 206, a rhombus 208, a diamond 210, and a rectangle 212. During the course of a text IM session, it becomes clear that User A would like for User B to use the ellipse 206 in a PowerPoint™ presentation A 214, and thus sends the ellipse 206 to User B via a Collaborative Pipe P1 216. Note that Collaborative Pipe P1 216 is separate from the text-based IM session used by User A and User B; thus, the text-based IM session is unaware of the artifact ellipse 206 that is being transported to User B. Thus, Collaborative Pipe P1 216 is a distinct unidirectional or bidirectional pipe that is defined by User A and User B. Thus, whenever User A wants to send a shape or other object to a particular clipboard, application, and/or presentation, User A simply “places” that object onto the Collaborative Pipe P1 216, and the object intelligently and automatically is directed to the appropriate clipboard/application. When Collaborative Pipe P1 216 is defined by Users A and B as being bidirectional, then anything that User B puts on the Collaborative Pipe P1 216 will be auto-populated onto User A's source (e.g., Paintbrush™ 218). Details of what constitutes a collaborative pipe (e.g., Collaborative Pipe P1 216) are shown in an exemplary manner below in FIGS. 3-4.

With reference now to FIG. 3, assume that a first user's IM 302 (User A) is working with an Application A 304 to create an artifact 306. This artifact 306 may be a graphical figure such as the ellipse 206 described in FIG. 2, a pointer to a file, a sub-routine such as an applet, object, etc. For example, assume that User A is a software developer and a second IM user (User B) is a software tester. Artifact 306 may be a defect identifier used by a program such as Configuration Management Version Control (CMVC). An exemplary defect identifier may be “d:152538; relase:ark.pdm; family: wplc . . . ” By sending this defect identifier to User B's IM 312, User A and User B can collaborate on addressing the problem identified by the defect identifier. As noted above, however, artifact 306 (and similarly artifact 308, described later), may be any artifact that is application specific (is specifically utilized by one or more applications). Furthermore, the artifact may be of a type that the IM application cannot process by itself, and is merely transmitted. That is, in one embodiment, the artifact that is placed on the collaborative pipe is an artifact that is in a format that the IM system cannot understand (e.g., an ellipse shape is an artifact that is not understood by the IM system Sametime™).

Returning to the example shown in FIG. 3, User A may send artifact 306 via a Pipe P1 310 to User B's IM 312 via an IM Network 314. Note that artifact 306 is independent of and invisible to an IM text message that is being sent to User B. Thus, when the artifact 306 reaches User B, it is received by an artifact routing logic 316, which strips off the artifact 306 attachment along with routing instructions (to the appropriate application and/or clipboard). The artifact is then routed to an appropriate application, which preferably utilizes a clipboard. For example, assume that artifact 306 is intended for use in Application B 318. In a preferred embodiment, artifact 306 is first pasted into Application B's clipboard 320, from which User B can call up (“copy”, “drag-and-drop”, etc.) the artifact 306 for use in a program that uses Application B 318. Alternatively, the artifact routing logic 316 can route the artifact 306 to a general purpose clipboard 322, which is associated with the IM session used by IM User B 312, and is accessible to Application B 318. Note that in one embodiment, general purpose clipboard 322 is specifically designed to support applications in a suite (e.g., Microsoft™ Office™), where the clipboard can store more than one buffer, while in another embodiment general purpose clipboard 322 is a generic buffer clipboard that can be utilized by any application.

Consider now a scenario in which User A creates two different artifacts (306 and 308). In one embodiment, each artifact is specific for a particular application being used by User B. For example, assume that artifact 306 is intended for use by Application B 318, while artifact 308 is intended for use in Application C 324. In this scenario, there are two collaborative pipes, P1 310 and P2 326. Collaborative pipe P2 326 operates in a substantially similar manner as that described above for collaborative pipe P1 310. In the example described, however, collaborative pipe P1 310 directs artifact 306 to Application B's clipboard 320, while collaborative pipe P2 326 directs artifact 308 to Application C's clipboard 328, from whence artifact 308 can be used in Application C 324. Note that artifact 308 also can alternatively be pasted into general purpose clipboard 322 as described above for artifact 306.

In the scenario described in FIG. 3, artifacts are routed by virtue of an attendant artifact routing logic 316 that directs which application (and/or clipboard) is to receive the artifact. FIG. 4, however, shows an alternative embodiment, in which artifacts are directly sent to an application (via a clipboard) using a collaborative pipe that, like that described in FIG. 3, is separate from and invisible to, a text message session. Thus, assume that User A's IM 402 and User B's IM 404 are engaged in a text message session 406 via an IM network 408. User A can send an artifact 410, which was created using Application A 412 via a collaborative pipe P1 414. Note that one end of collaborative pipe P1 414 is coupled to Application A 412, perhaps via Application A's clipboard 416 (from which artifact 410 was previously pasted). The other end of collaborative pipe P1 414 is coupled directly to Application B's clipboard 418, which supports Application B 420. Note that the text message session 406 and collaborative pipe P1 414 are independent, such that text message session 406 is “unaware” of any activity or functionality of the collaborative pipe P1 414.

Note that, in one embodiment, the collaborative pipes described above (e.g., 216 and 414) are persistent. That is, after the collaborative pipe is established in a manner described above for a first IM session, the same collaborative pipe can be re-used during another IM session by participants in the second IM session. Thus, as long as a first and second user have defined a collaborative pipe, then that pipe can be utilized by those same two users during subsequent IM sessions as long as the collaborative pipe is still defined and operational (appropriate connectors as described above are still in place).

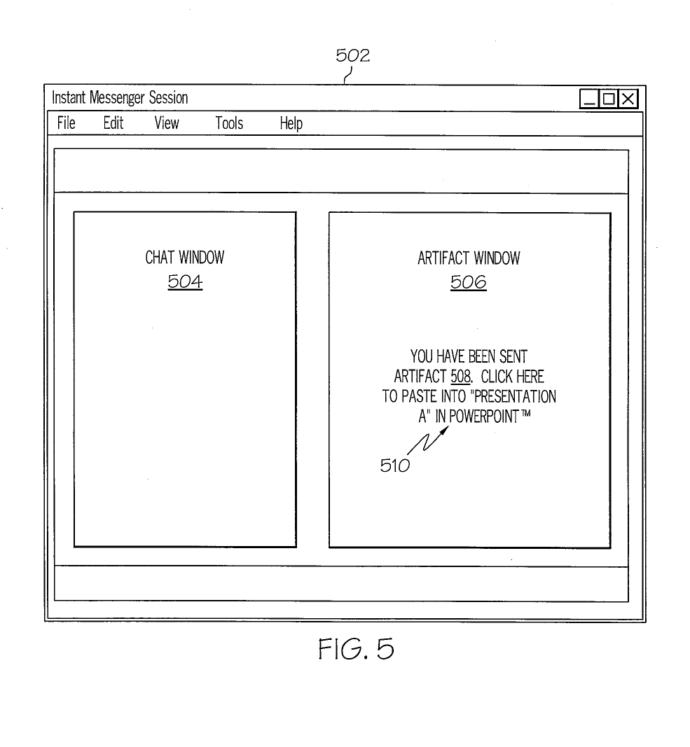

With reference now to FIG. 5, an exemplary Graphical User Interface (GUI) 502 for utilizing an artifact is shown. GUI 502 may be generated using a GUI functionality of OS 138 and CPM 148 shown in FIG. 1. GUI 502 has a traditional chat window 504 for entering and receiving IM text messages. However, GUI 502 also has an artifact window 506, which includes a message that an artifact 508 has been received, and that artifact 508 is to be used in “Presentation A” in PowerPoint™, and thus the artifact is directed to the appropriate program (“PowerPoint™”) and the appropriate file (“Presentation A”). By clicking the hot zone 510, artifact 508 is automatically cut/copied from the appropriate clipboard that is associated with the application that supports “Presentation A,” and is then pasted onto “Presentation A.”

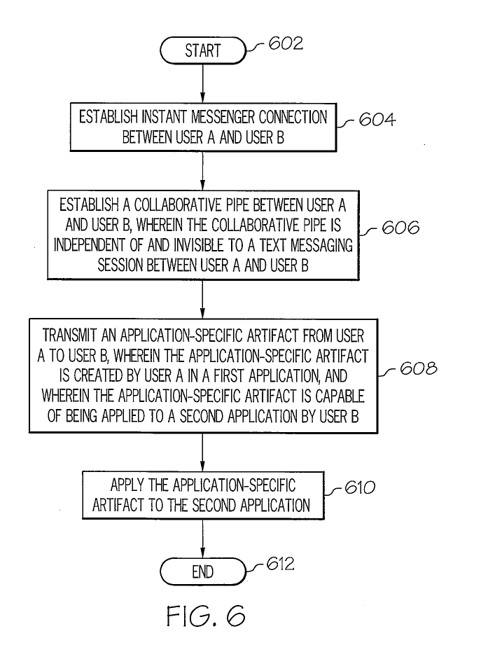

Referring now to FIG. 6, a high-level flow-chart of the examples described above is presented. After initiator block 602, which may be the result of a decision to collaborate via telecommunication on a project, an IM connection is established between User A and User B (block 604). A collaborative pipe is then established between User A and User B (block 606). Note that, as described above, the collaborative pipe is independent of the text messaging session between User A and User B. User A creates an artifact for use by User B, and transmits this artifact via the collaborative pipe (block 608). The artifact is received by User B and applied to the appropriate program (e.g., presentation) using the appropriate software application (block 610). The process ends at terminator block 612.

Note again that while most of the present disclosure describes examples of tunneling artifacts in an Instant Messaging scenario, the same principals taught herein are applicable to other forms of interactive teleconferences, including but not limited to video conferences, web conferences, conference telephone calls, etc. Note also that the application PowerPoint™ is defined as an exemplary graphics-based presentation application software, while Paintbrush™ is defined as an exemplary graphics creation application software. Note also that the term “invisible” in the claims is defined as the instant messaging session being both unaware of the artifact being transmitted in the collaborative pipe, as well as the instant messaging session being unable to interpret what the artifact represents.

Note also that the flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to limit the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A method for tunneling application-specific artifacts through an interactive instant messaging session, the method comprising:
engaging an interactive instant messaging session between a first user and a second user;
engaging a collaborative pipe between the first user and the second user, wherein the collaborative pipe is independent of and invisible to the interactive instant messaging session between the first user and the second user;
receiving, by the second user, an application-specific artifact from the first user, wherein the application-specific artifact is created by the first user by using a first application program; and
applying, by the second user, the application-specific artifact to a file that uses a second application program that is used by the second user.

2. The method of claim 1, further comprising:
routing the application-specific artifact to a clipboard that is directly coupled to the collaborative pipe between the first user and the second user.

3. The method of claim 2, wherein the clipboard is associated with a particular application program.

4. The method of claim 3, wherein the particular application program is selected from multiple application programs that are all capable of utilizing the application-specific artifact.

5. The method of claim 2, wherein the first application and the second application are different applications in a suite of applications that share the clipboard, and wherein the first application and the second application are both capable of utilizing the application-specific artifact.

6. The method of claim 1, wherein the collaborative pipe between the first user and the second user is a direct connection between the first application and a dedicated clipboard that is assigned to the second application.

7. A system for tunneling application-specific artifacts through an interactive instant messaging session, the system comprising:
an instant messaging logic for engaging an interactive instant messaging session between a first user and a second user;
a collaborative pipe manager for engaging a collaborative pipe between the first user and the second user, wherein the collaborative pipe is independent of and invisible to the instant messaging session between the first user and the second user;
a network interface for receiving, by the second user, an application-specific artifact from the first user, wherein the application-specific artifact is created by the first user by using a first application program; and
an applying logic, in the instant messaging logic, for applying, by the second user, the application-specific artifact to a presentation that uses a second application program, wherein the second application program is used by the second user.

8. The system of claim 7, farther comprising:
an artifact routing logic for routing the application-specific artifact to a clipboard that is directly coupled to the collaborative pipe between the first user and the second user.

9. The system of claim 8, wherein the clipboard is associated with a particular application program.

10. The system of claim 9, wherein the particular application program is selected from multiple application programs that are all capable of utilizing the application-specific artifact.

11. The system of claim 7, wherein the first application and the second application are different applications in a suite of applications that share the clipboard, and wherein the application-specific artifact is a graphical shape.

12. The system of claim 7, wherein the collaborative pipe between the first user and the second user is a direct connection between the first application and a dedicated clipboard that is assigned to the second application.

13. A computer-readable medium encoded with a computer program for tunneling application-specific artifacts through an interactive instant messaging session, the computer program comprising computer executable instructions configured for:
engaging an interactive instant messaging session between a first user and a second user;
engaging a collaborative pipe between the first user and the second user, wherein the collaborative pipe is independent of and invisible to the interactive instant messaging session between the first user and the second user;
receiving, by the second user, an application-specific artifact from the first user, wherein the application-specific artifact is created by the first user by using a first application program; and
applying, by the second user, the application-specific artifact to a file that uses a second application program, wherein the second application program is used by the second user.

14. The computer-readable medium of claim 13, wherein the computer executable instructions are further configured for:
routing the application-specific artifact to a clipboard that is directly coupled to the collaborative pipe between the first user and the second user.

15. The computer-readable medium of claim 14, wherein the clipboard is associated with a particular application program.

16. The computer-readable medium of claim 15, wherein the particular application program is selected from multiple application programs that are all capable of utilizing the application-specific artifact.

17. The computer-readable medium of claim 14, wherein the first application and the second application are different applications in a suite of applications that share the clipboard.

18. The computer-readable medium of claim 13, wherein the collaborative pipe between the first user and the second user is a direct connection between the first application and a dedicated clipboard that is assigned to the second application.

19. The computer-useable medium of claim 13, wherein the computer executable instructions are deployable to a client computer from a server at a remote location.

20. The computer-useable medium of claim 13, wherein the computer executable instructions are provided by a service provider to a customer on an on-demand basis.
